(19) United States
(12) Patent Application Publication
(10) Pub. No.: US 2019/0139042 A1
(43) Pub. Date: May 9, 2019

(54) DEVICES, SYSTEMS, AND METHODS FOR REAL-TIME PAYMENTS AT THE POINT OF SALE

(71) Applicant: Bonne Idee, Millville, PA (US)

(72) Inventor: Tabitha MCCORMICK, Millville, PA (US)

(21) Appl. No.: 15/964,975

(22) Filed: Apr. 27, 2018

Related U.S. Application Data
(60) Provisional application No. 62/583,531, filed on Nov. 9, 2017.

(51) Int. Cl. G06Q 20/40; G06Q 20/10; G06Q 20/20; G06Q 20/42; G06K 9/22

(52) U.S. Cl. CPC G06Q 20/401; G06Q 20/10; G06K 9/22; G06Q 20/42; G06Q 20/20

(57) ABSTRACT

A device includes memory and a processor configured to perform the following steps during a single visit by a customer to a merchant location: receive a sales amount, encode the sales amount and merchant financial information into an image, display the image on the display device, determine that the image has been scanned by a user device, and remove the image from the display device. The device is further configured to receive a confirmation number, transmit via a secure Internet connection with the financial institution a query requesting validation of the confirmation number, and receive via a secure Internet connection with the financial institution a confirmation message indicating that the confirmation number is valid. The device also displays information indicating that payment of the sales amount has been confirmed.

This application claims the benefit of U.S. Provisional Application No. 62/583,531 filed Nov. 8, 2017, the contents of which are incorporated herein by reference.

### TECHNICAL FIELD

This specification relates generally to payment systems, and more particularly to devices, systems, and methods for real-time payments at the point of sale.

### BACKGROUND

Payment systems form a vital part of the world's financial system—they underpin the services that enable funds to be transferred between financial institutions, for example, in connection with commercial transactions. Payment systems enable people to purchase groceries, pay a deposit on a house, withdraw money from a cash machine, pay by direct debit, receive salary payments directly into a financial institution account, transfer money via a smartphone, etc.

Existing payment systems at the point-of-sale are limited to four methods of payment: (1) cash, (2) check, (3) payment via Automated Clearing House (ACH), and (4) electronic funds transfer (EFT) (used with debit and credit cards). Existing financial institutions and payment applications utilize one or more of these methods to make payments and to transfer funds.

At a point-of-sale within a commercial establishment, cash, checks, and cards are the preferred methods of payment. ACH is rarely used, unless a merchant has subscribed to a service that allows a check to be converted to an electronic payment.

Each of the existing methods of payment has certain advantages and disadvantages. For example, cash (if it is not counterfeit) is guaranteed. However, cash is subject to employee theft, and the possibility of errors when giving change back to the customer. Many customers prefer not to carry cash, especially for large purchases.

Checks pose a higher level of risk for a merchant, because there is a possibility that the funds may not be available in the customer's account the next business day (or later) at the time of settlement. Several services are available to merchants to determine the risk associated with accepting a check and whether the account associated with the check is valid. However, a funds availability determination at the time of purchase still does not guarantee that the funds will be available in the customer's account at the time of settlement. Checks converted to ACHs can settle at a later time (either later the same day if service is provided by the merchant's financial institution, or next business day), at which time the funds may no longer be in the customer's account. Checks can also be stolen and/or forged. For all of these reasons, a merchant accepts a higher risk when agreeing to allow a customer to pay by check.

Debit and credit cards provide the merchant a higher assurance of payment receipt through the authorization process. After an authorization is obtained, the funds are transferred to the merchant's account several days later (the merchant can choose to pay extra to allow the funds to settle faster). Card payments are less risky, but are still subject to disputes and chargebacks by the customer. There is also a risk that a card may be counterfeit or stolen.

From the customer's perspective, the ACH, check, and card payment methods pose different problems. The largest drawback, by far, of these payment methods is that they all involve the merchant taking custody, either physically or electronically, of the customer's financial information. ACH and check payments require the customer to provide the customer's name and financial institution account number. Debit and credit card payments require the customer to provide electronic records of customer names, addresses, card numbers, card expiration dates, card CVV codes, and sometimes Personal Identification Numbers (PINs). Even if a merchant is compliant with Payment Card Industry (PCI) standards (which dictate the security requirements surrounding the storage and transmission of card data), there is no guarantee that a knowledgeable hacker will not be able to access and steal the customer's information from the merchant's system.

### SUMMARY

There is a need for a payment method that allows the following actions to take place while the customer is physically present at the point of sale during a single visit to the merchant's commercial establishment and during a single electronic communication session between a merchant's device and a customer device: (1) the merchant communicates to the customer at the point of sale where payment should be sent (e.g., to the merchant's financial institution account), in a secure manner that does not reveal the merchant's account information to the customer, (2) the customer causes payment to be made from the customer's financial institution account to the merchant's financial institution account while the customer is physically present at the point of sale, and (3) the merchant (or an employee thereof) present at the point-of-sale is able to confirm that payment to the merchant's financial institution account has been successful.

The present specification describes inventive systems, devices, and methods that enable an improved payment method which advantageously makes it possible for a payment associated with a commercial transaction conducted by a customer during a visit by the customer to a merchant's commercial establishment (such as a store, a restaurant, a movie theater, etc.) to be made between the customer's financial institution account and the merchant's financial institution account during the visit. While the customer is physically present during a single visit to the commercial establishment, the purchaser's financial institution account is debited by an amount equal to purchase amount, and within seconds, the seller's account is credited by the same amount. In one embodiment, these actions take place during a single communication session between a merchant device and a customer device. In another embodiment, these actions take place during a single communication session associated with a particular sales amount.

Advantageously, payments made using the inventive payment method are less risky for the merchant because they are final. There are no chargeback or dispute rights for the purchaser. The purchaser cannot later state that the payment was unauthorized.

The inventive payment method utilizes a real-time payments network that allows immediate payments. In a preferred embodiment, the inventive payment method utilizes the Real-Time Payments (RTP®) network maintained by The Clearing House (TCH).

The Clearing House is a banking association and payments company that is owned by the largest commercial financial institutions in the United States and dates back to 1853. The Clearing House Association L.L.C., is a nonpartisan organization that engages in research, analysis, advocacy and litigation focused on financial regulation that supports a safe, sound and competitive banking system. The Clearing House Payments Company L.L.C. owns and operates core payments system infrastructure in the United States, clearing and settling nearly $2 trillion in U.S. dollar payments each day, representing half of all commercial ACH and wire volume.

TCH launched the RTP® network (referred to herein as “RTP”) in 2017. RTP is the first new core payments infrastructure in the U.S. in more than 40 years. The new RTP system was designed and built through the collaborative effort of TCH's 25 owner financial institutions and meets the objectives of the Federal Reserve Faster Payments Task Force. RTP is open to all U.S depository institutions with a goal of reaching ubiquity by 2020.

RTP makes possible a new payment method for use in transferring funds, for example, in connection with commercial transactions. The RTP network enables payments to be completed immediately. Electronic payments made via the RTP network do not settle with the delays involved with cards or ACH. For example, in a commercial transaction between a seller and purchaser, the purchaser's financial institution account is debited, and within seconds the seller's account is credited.

Advantageously, payments made using the inventive method do not require the purchaser to provide his or her financial information to the merchant. The purchaser's financial information remains securely stored at the purchaser's financial institution and is not transmitted to any device associated with the merchant.

Advantageously, payments made using the inventive payment method are less risky because they are “push” only. This payment method only accepts credit entries. A merchant cannot debit a customer's account. Payments are initiated by the customer online with identity authentication through login credentials. The chance of a thief obtaining these credentials to send a fraudulent payment is low.

In accordance with an embodiment, a device is provided. The device is connected to a financial institution that is connected to a real-time payments network. The device includes an interface connected to a financial institution, the interface adapted to transmit and receive messages, a memory adapted to store first data, and a display device adapted to display second data and images. The device also includes a processor configured to: during a single visit by a customer to a merchant location, receive a sales amount; during the single visit, encode the sales amount, a merchant name, a financial institution routing number associated with a financial institution connected to a real-time payments network, and an account number associated with a financial institution account into an image; during the single visit, display the image on the display device; during the single visit, determine that a predetermined event has occurred; during the single visit, remove the image from the display device in response to determining that the predetermined event has occurred; during the single visit, display on the display device a prompt for a confirmation number; during the single visit, receive a confirmation number; during the single visit, transmit to a device associated with the financial institution, via a secure Internet connection, a query requesting validation of the confirmation number; during the single visit, receive, via the secure Internet connection, a confirmation message indicating that the confirmation number is valid; and during the single visit, display on the display device information indicating that payment of the sales amount to the financial institution account has been confirmed.

In one embodiment, the real-time payments network is the Real-Time Payments (RTP®) network maintained by The Clearing House (TCH).

In another embodiment, the device is located at a point-of-sale at the merchant location.

In another embodiment, the merchant location comprises one of a retail store, a restaurant, and a movie theater.

In another embodiment, the device is one of: a device fixed to a surface within the merchant location, and a mobile device.

In another embodiment, the predetermined event is one of: the image has been scanned by the user device, and the image has been displayed for a predetermined period of time.

In another embodiment, the image is an image of a familiar object.

In another embodiment, the processor uses a symmetric key algorithm to encode the sales amount, a merchant name, a financial institution routing number associated with a financial institution, and an account number associated with a financial institution account into an image.

In accordance with another embodiment, a method is provided. The method includes the following steps: during a single visit by a customer to a merchant location, receiving a sales amount; during the single visit, encoding the sales amount, a merchant name, a financial institution routing number associated with a financial institution connected to a real-time payments network, and an account number associated with a financial institution account into an image; during the single visit, displaying the image on a display device; during the single visit, determining that a predetermined event has occurred; during the single visit, removing the image from the display device in response to determining that the predetermined event has occurred; during the single visit, displaying on the display device a prompt for a confirmation number; during the single visit, receiving a confirmation number; during the single visit, transmitting to a device associated with the financial institution, via a secure Internet connection with the financial institution, a query requesting validation of the confirmation number; during the single visit, receiving, via the secure Internet connection with the financial institution, a confirmation message indicating that the confirmation number is valid; and during the single visit, displaying on the display device information indicating that payment of the sales amount to the financial institution account has been completed.

In one embodiment, the real-time payments network is the Real-Time Payments (RTP®) network maintained by The Clearing House (TCH).

In another embodiment, the method includes the following steps: during a single visit by a customer to a merchant location, receiving a sales amount, by a processing device located at the merchant location; during the single visit, encoding the sales amount, a merchant name, a financial institution routing number associated with a financial institution connected to the real-time payments network, and an account number associated with a financial institution account into an image, by the processing device; during the single visit, displaying the image on a display device, by the processing device; during the single visit, determining that a predetermined event has occurred, by the processing device; during the single visit, removing the image from the display device in response to determining that the predetermined event has occurred, by the processing device; during the single visit, displaying on the display device a prompt for a confirmation number, by the processing device; during the single visit, receiving a confirmation number, by the processing device; during the single visit, transmitting to a device associated with the financial institution, via a secure Internet connection to the financial institution, a query requesting validation of the confirmation number, by the processing device; during the single visit, receiving, via a secure Internet connection with the financial institution, a confirmation message indicating that the confirmation number is valid, by the processing device; and during the single visit, displaying on the display device information indicating that payment of the sales amount to the financial institution account has been confirmed, by the processing device.

In another embodiment, the processing device is located at a point-of-sale at the merchant location.

In another embodiment, the merchant location comprises one of a retail store, a restaurant, and a movie theater.

In another embodiment, the processing device is one of: a device fixed to a surface within the merchant location, and a mobile device.

In another embodiment, the predetermined event is one of: the image has been scanned by the user device, and the image has been displayed for a predetermined period of time.

In accordance with another embodiment, a device is provided. The device includes a mobile banking app that is configured to securely connect to a financial institution. The device also includes: an interface connected to a financial institution connected to a real-time payments network, the interface adapted to transmit and receive messages; a memory adapted to read and transmit a first account number associated with a financial institution account; and a display device adapted to display second data and images. The device further includes a processor configured to: during a single visit by a user to a merchant location, scan an image; during the single visit, decode the image to obtain a sales amount, a name of a merchant, a routing number of the financial institution connected to the real-time payments network, and a first account number of a first financial institution account; during the single visit, display on the display device an option to confirm payment of the sales amount from a second financial institution account to the first financial institution account; during the single visit, receive a selection of the option; during the single visit, transmit via a secure Internet connection with a financial institution a request to make a payment of the sales amount from the second financial institution account to the first financial institution account; during the single visit, receive via a secure Internet connection a message confirming that the payment of the sales amount has been completed; and during the single visit, display on the display device information confirming that the payment of the sales amount has been completed.

In accordance with another embodiment, a device is provided. The device is connected to a financial institution. The device includes an interface adapted to transmit and receive messages; a memory adapted to store first data; and a display device adapted to display second data and images. The device also includes a processor configured to: during a single communication session with a customer device, receive a sales amount; during the single communication session, encode the sales amount, a merchant name, a financial institution routing number associated with a financial institution connected to a real-time payments network, and an account number associated with a financial institution account into an image; during the single communication session, display the image on the display device; during the single communication session, determine that a predetermined event has occurred; during the single communication session, remove the image from the display device in response to determining that the predetermined event has occurred; during the single communication session, display on the display device a prompt for a confirmation number; during the single communication session, receive a confirmation number; during the single communication session, transmit to a device associated with the financial institution, via a secure Internet connection, a query requesting validation of the confirmation number; during the single communication session, receive, via a secure Internet connection with the financial institution, a confirmation message indicating that the confirmation number is valid; and during the single communication session, display on the display device information indicating that payment of the sales amount to the financial institution account has been confirmed.

In accordance with another embodiment, a device is provided. The device is connected to a financial institution. The device includes an interface connected to a financial institution, the interface adapted to transmit and receive messages; a memory adapted to store first data; and a display device adapted to display second data and images. The device also includes a processor configured to: during a single communication session associated with a particular sales amount, receive a sales amount; during the single communication session, encode the particular sales amount, a merchant name, a financial institution routing number associated with a financial institution connected to a real-time payments network, and an account number associated with a financial institution account into an image; during the single communication session, display the image on the display device; during the single communication session, determine that a predetermined event has occurred; during the single communication session, remove the image from the display device in response to a determining that the predetermined event has occurred; during the single communication session, display on the display device a prompt for a confirmation number; during the single communication session, receive a confirmation number; during the single communication session, transmit to a device associated with the financial institution, via a secure Internet connection, a query requesting validation of the confirmation number; during the single communication session, receive, via a secure Internet connection to the financial institution, a confirmation message indicating that the confirmation number is valid; and during the single communication session, display on the display device information indicating that payment of the particular sales amount to the financial institution account has been confirmed.

These and other advantages of the present disclosure will be apparent to those of ordinary skill in the art by reference to the following Detailed Description and the accompanying drawings.

### BRIEF DESCRIPTION OF THE DRAWINGS

FIG. 1 shows a communication system in accordance with an embodiment;

FIG. 2 shows components of a customer device in accordance with an embodiment;

FIG. 3 shows components of a merchant device in accordance with an embodiment;

FIGS. 4A-4B describe a method of completing a transaction via a real-time payments network in accordance with an embodiment;

FIG. 5 describes a method of completing a transaction via a real-time payments network in accordance with an embodiment;

FIG. 6 shows a customer holding a customer device and a cashier operating a merchant device at a merchant location in accordance with an embodiment;

FIG. 7 shows a page that may be displayed on a merchant device in accordance with an embodiment;

FIG. 8 shows an image containing encoded information that may be displayed by a merchant device in accordance with an embodiment;

FIG. 9 shows a blank page that may be displayed on a merchant device after an image is removed in accordance with an embodiment;

FIG. 10 shows a page including an option to confirm payment that may be displayed on a customer device in accordance with an embodiment;

FIG. 11A shows a page displaying a confirmation number that may be displayed on a customer device in accordance with an embodiment;

FIG. 11B shows a page that may be displayed on a customer device in accordance with an embodiment;

FIG. 12 shows a prompt page that may be displayed on a merchant device in accordance with an embodiment;

FIG. 13 shows a confirmation page that may be displayed on a merchant device in accordance with an embodiment;

FIG. 14 shows a page that may be displayed on a merchant device in accordance with an embodiment;

FIG. 15 shows a merchant device that is fixed to a table inside a restaurant in accordance with an embodiment;

FIG. 16 shows a merchant device that is a mobile device carried by a server inside a restaurant in accordance with an embodiment; and

FIG. 17 shows a high-level block diagram of an exemplary computer that may be used to implement certain embodiments of the invention.

### DETAILED DESCRIPTION

The present specification describes inventive systems, devices, and methods that enable an improved payment method which advantageously makes it possible for a payment associated with a commercial transaction conducted by a customer during a visit by the customer to a merchant's commercial establishment (such as a store, a restaurant, a movie theater, etc.) to be completed during the visit. While the customer is physically present during a single visit to the commercial establishment, the purchaser's financial institution account is debited by an amount equal to purchase amount, and within seconds, the seller's account is credited by the same amount. In one embodiment, these actions may be performed during a single communication session between a merchant device and a customer device. In another embodiment, these actions may be performed during a single communication session associated with a particular sales amount.

Advantageously, payments made using the inventive payment method are less risky for the merchant because they are final. There are no chargeback or dispute rights for the purchaser. The purchaser cannot later state that the payment was unauthorized.

The inventive payment method utilizes a real-time payments network that allows immediate or real-time payments between entities, for example, between financial institutions. In a preferred embodiment, the inventive payment method utilizes the Real-Time Payments (RTP®) network maintained by The Clearing House (TCH). Other real-time payment networks may be used.

Advantageously, payments made using the inventive method do not require the purchaser to provide his or her financial information to the merchant. The purchaser's financial information remains securely stored at the purchaser's financial institution and is not transmitted to any device associated with the merchant.

In accordance with an embodiment, a device is provided. The device is connected to a secure Internet connection. The device includes an interface connected to a financial institution that is connected to a real-time payments network, the interface adapted to transmit and receive messages that conform to requirements of the real-time payments network, a memory adapted to store first data, and a display device adapted to display second data and images. The device also includes a processor configured to perform the following steps: during a single visit by a customer to a merchant location, receive a sales amount; during the single visit, encode the sales amount, a merchant name, a financial institution routing number associated with a financial institution connected to a real-time payments network, and an account number associated with a financial institution account into an image; during the single visit, display the image on the display device; during the single visit, determine that a predetermined event has occurred; during the single visit, remove the image from the display device in response to a determination that a predetermined event has occurred; during the single visit, display on the display device a prompt for a confirmation number; during the single visit, receive a confirmation number; during the single visit, transmit to a device associated with the financial institution, via a secure Internet connection, a query requesting validation of the confirmation number; during the single visit, receive, via a secure Internet connection, a confirmation message indicating that the confirmation number is valid; and during the single visit, display on the display device information indicating that payment of the sales amount to the financial institution account has been confirmed.

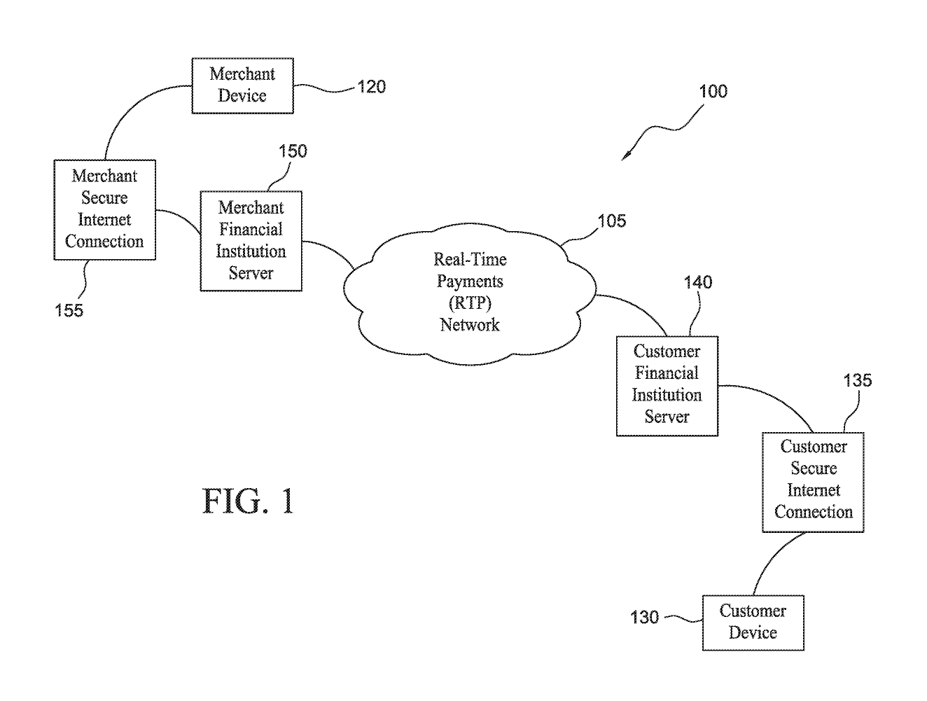

FIG. 1 shows a communication system in accordance with an embodiment. Communication system 100 includes a real-time payments (RTP) network 105, a merchant device 120, a customer device 130, a customer financial institution server 140, a merchant financial institution server 150, a customer secure Internet connection 135, and a merchant secure Internet connection 155.

RTP Network 105 includes a real-time payments network in which payments between financial institutions are settled immediately. In one embodiment, RTP network 105 is the Real-Time Payments (RTP®) network administered by The Clearing House (TCH). In other embodiments, other real-time payment networks and systems may be used.

In accordance with an embodiment, communications (including, for example, messages, queries, requests, etc.) transmitted via RTP network 105 may be transmitted in accordance with ISO 20022 via RTP network 105.

Merchant device 120 is located at a merchant location, which is associated with a commercial establishment owned or managed by a merchant. For example, the merchant location may include a retail store, a movie theater, a restaurant, or any other location where a customer may be required to make a payment to a merchant. Merchant device 120 may be placed near a cashier, for example. Merchant device 120 includes functionality to connect to and communicate with the merchant's financial institution, for example, via the Internet or a cellular connection. Merchant device 120 may also be integrated with the merchant's point-of-sale system.

Customer device 130 may be any portable or mobile processing device that a customer may carry. For example, customer device 130 may be a smart phone, a tablet, a smart watch, etc. Customer device 130 includes functionality to connect to the customer's financial institution, for example, via a secure Internet or cellular connection. For example, customer device 130 may include a mobile banking app having the capability to securely communicate payment instructions to the customer financial institution.

Customer financial institution server 140 is associated with a financial institution associated with the user. Customer financial institution server 140 may be any suitable processing device commonly used by financial institutions to process transactions. For example, customer financial institution server 140 may be a personal computer, a mainframe computer, a server computer, a workstation, computer, etc. Other types of processing devices may be used. Customer financial institution server 140 includes functionality to connect to and communicate with other financial institutions via RTP network 105.

Merchant financial institution server 150 is associated with a financial institution associated with the merchant. Merchant financial institution server 150 may be any suitable processing device commonly used by financial institutions to process transactions. For example, merchant financial institution server 150 may be a personal computer, a mainframe computer, a server computer, a workstation, computer, etc. Other types of processing devices may be used. Merchant financial institution server 150 includes functionality to connect to and communicate with other financial institutions via RTP network 105.

Customer secure Internet connection 135 comprises a secure connection between customer device 130 and customer financial institution server 140 via the Internet. Merchant secure Internet connection 155 comprises a secure connection between merchant device 120 and merchant financial institution server 150 via the Internet. Customer secure Internet connection 135 and/or merchant secure Internet connection 155 may also include other types of networks such as an Ethernet, an intranet, a Fibre Channel-based storage area network (SAN), an iSCSI-based network, a local area network (LAN), a wide area network (WAN), a cellular network, a Wi-Fi network, or another type of wireless network. The secure Internet connections allow the merchant device to communicate with the merchant financial institution server and the customer device to communicate with the customer financial institution server. Communications over these connections may be encoded, for example.

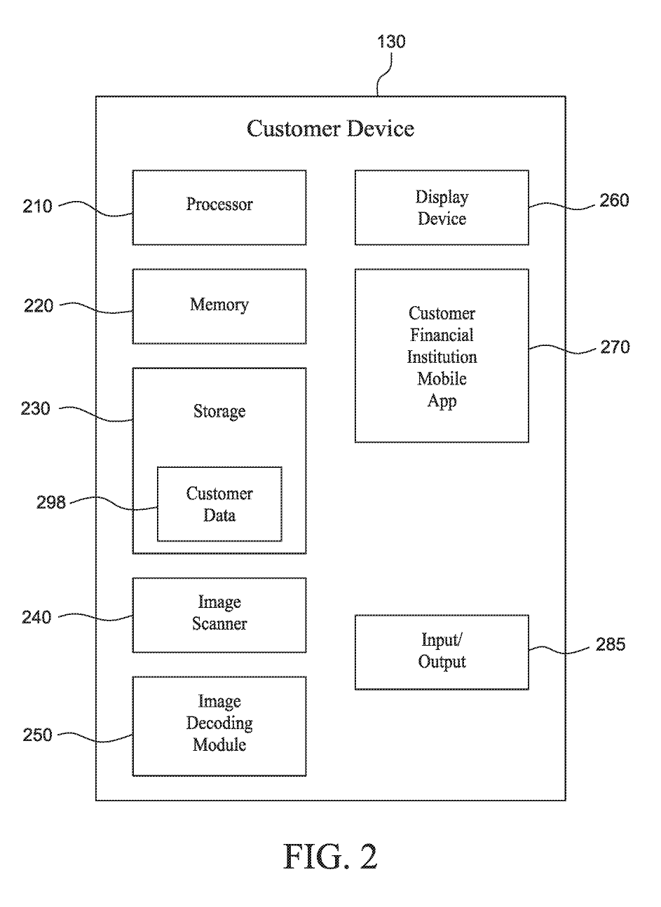

FIG. 2 shows components of a customer device in accordance with an embodiment. Customer device 130 includes a processor 210, a memory 220, a storage 230, an image scanner 240, an image decoding module 250, a display device 260, a customer financial institution mobile app 270, and an input/output device 285.

Processor 210 controls and orchestrates the operations of various components of customer device 130. Memory 220 is adapted to store data. For example, memory 220 may include random-access memory (RAM).

Storage 230 is adapted to store data. Storage 230 may include a long-term data storage device such as a disk drive. Storage 230 may store information relating to the user of customer device 130, such as the customer's mobile app username and password, etc. In the illustrative embodiment, such information is stored in storage 230 as customer data 298.

Image scanner 240 is adapted to scan an image. For example, image scanner 240 may from time to time scan an image displayed on a display device of another device. Any suitable image scanning device may be used. The image scanner 240 may be embedded in the customer financial institution mobile app 270. Alternatively, the image scanner 240 may be independent of customer financial institution mobile app 270, with the ability to transfer data into the mobile app.

Image decoding module 250 is adapted to decode an image to obtain one or more items of information. For example, image decoding module 250 may from time to time decode an image to obtain information such as a sales amount, a name of a merchant, a financial institution routing number, an account number of a financial institution account, and other types of information. Image decoding module 250 may include software and/or hardware (circuitry).

Image decoding module 250 may use any suitable decoding system, method or algorithm. In one embodiment, image decoding module 250 uses a symmetric-key algorithm to decode an image. For example, a key may be shared between merchant device 120 and customer device 130. Other encryption systems may be used.

Display device 260 is adapted to display data and images. For example, display device 260 may be a display screen of a smart phone, cell phone, or tablet device.

Customer financial institution mobile app 270 is adapted to obtain certain items of information from an image decoding module, and to instruct a server computer associated with a financial institution, via a secure Internet connection, to make a payment of a sales amount from a first financial institution account at the financial institution to a second financial institution account at a second financial institution.

In the illustrative embodiment, customer financial institution mobile app 270 is adapted to transmit and receive messages to customer financial institution server 140 via customer secure Internet connection 135. For example, customer mobile banking app 270 may format, encode, or otherwise process a payment message prior to transmitting the payment message via secure Internet connection 135. Customer Financial Institution Server 140 may interpret, decode, or otherwise process a payment message received from customer device 130 before transmitting the payment message to Merchant Financial Institution Server 150, or causing a payment to be made in accordance with the payment message, via the RTP network 105.

Input/output device 285 is adapted to receive information from a user and/or to provide information to the user. For example, input/output device 285 may include one or more buttons, a keyboard, one or more LED lights, a touchscreen capable of detecting the touch of a user, a camera, a microphone, etc.

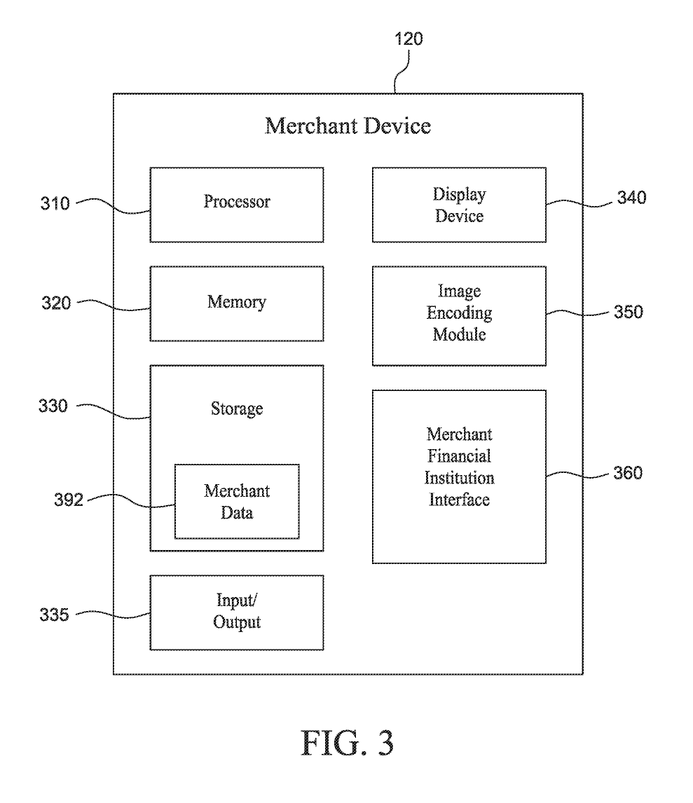

Merchant device 120 comprises a processing device capable of communicating securely with the financial institution via the Internet. FIG. 3 shows components of a merchant device in accordance with an embodiment. Merchant device 120 includes a processor 310, a memory 320, a storage 330, an input/output device 335, a display device 340, an image encoding module 350, and a merchant financial institution interface 360.

Processor 310 controls and orchestrates the operations of various components of merchant device 120. Memory 320 is adapted to store data. For example, memory 320 may include random-access memory (RAM).

Storage 330 is adapted to store data. Storage 330 may include a long-term data storage device such as a disk drive. Storage 330 stores information relating to a merchant (e.g., the owner of the store or restaurant located at a merchant premises). Such information may include, for example, the name of the merchant, information identifying an account at a financial institution associated with the merchant, a routing number associated with the merchant's financial institution, etc. In the illustrative embodiment of FIG. 3, such information is stored in storage 330 as merchant data 392.

Input/output device 335 is adapted to receive information from a user and/or to provide information to the user. For example, input/output device 335 may include one or more buttons, a keyboard, one or more LED lights, a touchscreen capable of detecting the touch of a user, a camera, a microphone, etc.

Display device 340 is adapted to display data and images. For example, display device 340 may be a display screen of a computer terminal or other processing device.

Image encoding module 350 is adapted to encode one or more items of information into an image. For example, image encoding module 350 may from time to time encode information such as a sales amount, a name of a merchant, a financial institution routing number, an account number of a financial institution account, and/or other types of information into an image. In an embodiment, image encoding module 350 encodes information into an image of well-known real-world objects, such as a landscape, a building, a person, a table, etc. In another embodiment, image encoding module 350 encodes information into an abstract image, such as a pattern of colors, a pattern of dots, an arrangement of pixels that appears random to the human eye, etc. Image encoding module 350 may include software and/or hardware (circuitry).

Image encoding module 350 may use any suitable encryption system, method or algorithm. In one embodiment, image encoding module 350 uses a symmetric-key algorithm to encode image into an image. For example, a key may be shared between merchant device 120 and customer device 130. Other encryption systems may be used.

Merchant financial institution interface 360 is adapted to transmit and receive messages via secure Internet connection 155 to merchant financial institution server 150. Merchant financial institution interface 360 may format, encode, or otherwise process a message prior to transmitting the message via secure Internet connection 155. Merchant financial institution interface 360 may interpret, decode, or otherwise process a message received from another device before providing the message to processor 310 or another component of merchant device 120.

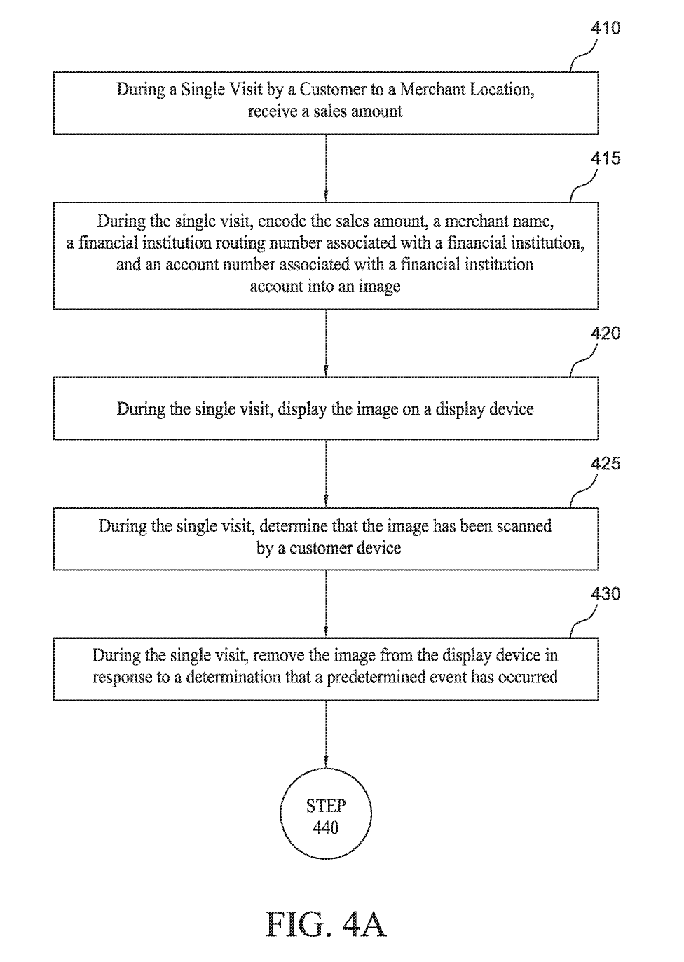

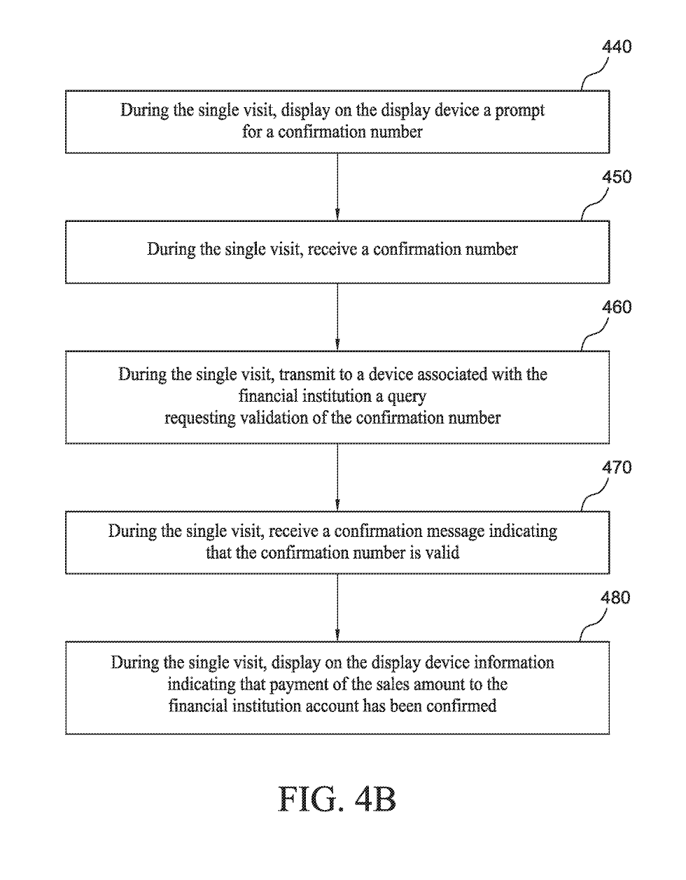

FIGS. 4A-4B describe a method of completing a transaction via a real-time payments network in accordance with an embodiment. In the illustrative embodiment, the steps of FIGS. 4A-4B are performed by a merchant device such as merchant device 120 of FIGS. 1 and 3.

At step 410, during a single visit by a customer to a merchant location, a sales amount is received. In an illustrative embodiment, input/output device 335 may enable a user to enter a sales amount via a keyboard, a touchscreen, a microphone, etc. Processor 310 receives the sales amount and may, for example, store the sales amount in memory 320.

At step 415, during the single visit, the sales amount, a merchant name, a financial institution routing number associated with a financial institution, and an account number associated with a financial institution account are encoded into an image. Processor 310 accesses merchant data 392 to obtain the merchant name, the routing number of the merchant's financial institution, and the account number of the merchant's financial institution account. Processor 310 provides the merchant name, the routing number of the merchant's financial institution, and the account number of the merchant's financial institution account, and the sales amount to image encoding module 350. Image encoding module 350 encodes the sales amount, the merchant name, the routing number of the merchant's financial institution, and the account number of the merchant's financial institution account into an image. Other information may be encoded in the image.

At step 420, during the single visit, the image is displayed on a display device. Processor 310 causes display device 340 to display the image containing the encoded information. As discussed above, the image may be an image of one or more familiar real-world objects or may include abstract patterns or seemingly random colors or other visual components.

At step 425, during the single visit, a determination is made that the image has been scanned by a customer device. Processor 310 determines that the image has been scanned by a second device, such as a user's smart phone. For example, a second device may transmit a signal to merchant device 120 indicating that it has completed scanning of the image.

At step 430, during the single visit, the image is removed from the display device in response to the determination that the image has been scanned by the customer device. For example, when processor 310 determines that the image has been scanned by the second device, processor 310 causes the image to be removed from display device 340.

In other embodiments, processor 310 removes the image when it is determined that a predetermined event has occurred. For example, in one embodiment, processor 310 causes the image to be displayed on display device 340 for a predetermined period of time (e.g., ten seconds). When the processor 310 determines that the image has been displayed for the predetermined period of time, processor 310 removes the image from the display device automatically, regardless of whether or not the second device successfully scanned the image.

Advantageously, removal of the image from the display device after a short period of time eliminates or reduces the possibility that the image may be scanned by a counterfeit reader, thus reducing the risk that the merchant's information may be stolen and used fraudulently.

After step 430, the routine proceeds to step 440 (shown in FIG. 4B). At step 440, during the single visit, a prompt for a confirmation number is displayed on the display device. Processor 310 causes a message prompting a user to enter a confirmation number to be displayed on display device 340.

At step 450, during the single visit, a confirmation number is received from the customer's financial institution and displayed on customer device 130. A user (who may be a customer or an employee of the merchant) enters a confirmation number via input/output device 335. For example, the confirmation number may be entered via a keyboard or via a touchscreen.

At step 460, during the single visit, a query requesting validation of the confirmation number is transmitted from merchant device 120 to a device associated with the financial institution, via secure Internet connection 155. Processor 310 causes merchant financial institution interface 360 to transmit to merchant financial institution server 150, via secure merchant Internet connection 155, a query requesting validation of the confirmation number. Merchant financial institution interface 360 formats, encodes or otherwise processes the query as appropriate. The request may include information such as the confirmation number, the merchant name, the merchant's account number, etc.

At step 470, during the single visit, a confirmation message indicating that the confirmation number is valid is received, via secure Internet connection 155. Merchant financial institution interface 360 receives and provides to processor 360 a confirmation message indicating that the confirmation number is valid.

At step 480, during the single visit, information indicating that payment of the sales amount to the financial institution account has been confirmed is displayed on the merchant display device 120. Processor 310 causes display device 340 to display a message indicating that payment of the sales amount has been confirmed.

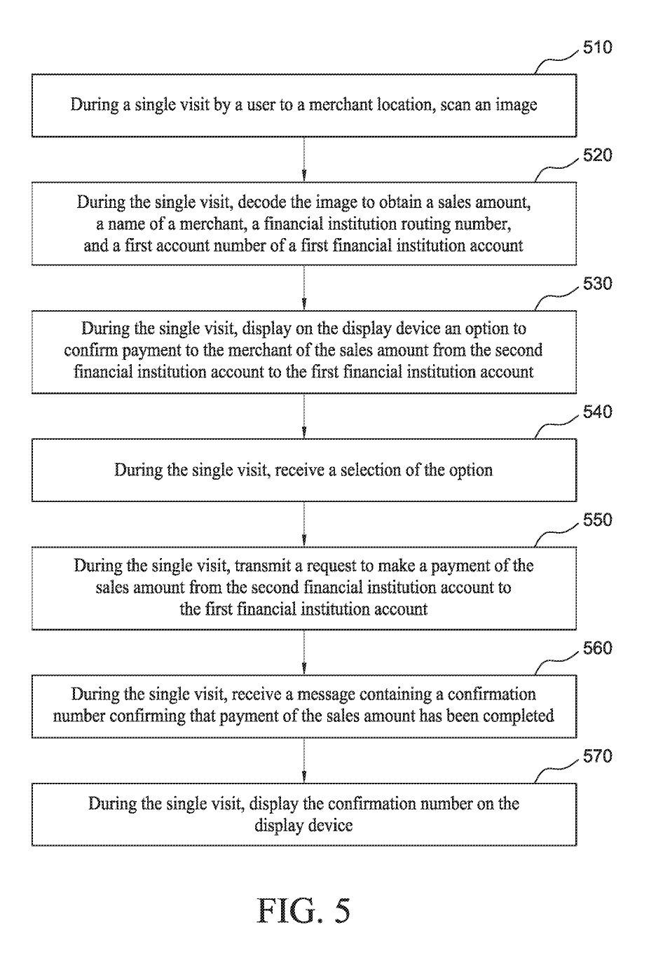

FIG. 5 describes a method of completing a transaction via a real-time payments network in accordance with an embodiment. The steps of FIG. 5 are performed by a customer device such as customer device 130 of FIGS. 1 and 2.

At step 510, during a single visit by a user to a merchant location, an image is scanned. In the illustrative embodiment of FIG. 2, image scanner 240 scans an image displayed by merchant device 120.

At step 520, during the single visit, the image is decoded to obtain a sales amount, a name of a merchant, a financial institution routing number, and a first account number of a first financial institution account. Image decoding module 250 (of customer device 130) decodes the image to obtain a sales amount, a name of a merchant, a financial institution routing number, and a first account number of a first financial institution account. Other information may be obtained from the image. Typically, the first financial institution account is a financial institution account of the merchant.

Customer device 130 does not store any of the scanned information such as the sales amount, the merchant name, the financial institution routing number, and the merchant's financial institution account number. Instead, the data is received by customer financial institution mobile app 270. Customer must be logged into and authenticated by the customer financial institution app 270 in order to process the transaction.

At step 530, during the single visit, an option to confirm payment of the sales amount from a second financial institution account to the first financial institution account is displayed on the display device. This may be performed, for example, by the customer financial institution mobile app 270. The second financial institution account is typically the customer's financial institution account. Accordingly, processor 210 causes display device 260 to display to the customer an option to confirm payment of the sales amount to the merchant. For example, a message allowing the customer to select “CONFIRM PAYMENT” or “CANCEL” may be displayed. Customer financial institution mobile app 270 may also allow the customer to choose from which account at that financial institution the payment should be withdrawn.

At step 540, during the single visit, a selection of the option is received. The customer uses input/output device 285 to enter a selection of the option. For example, the customer may select the option to confirm payment by using a touchscreen.

At step 550, during the single visit, a request to make a payment of the sales amount from the second financial institution account to the first financial institution account is transmitted. Customer financial institution mobile app 270, via secure Internet connection 135, transmits, to customer financial institution server 140, a request to make payment of the sales amount from the customer's financial institution account to the merchant's financial institution account. The request may include an instruction to make the payment via real-time payments network 105. The request may include information such as the payment amount, the sales amount, the merchant name, the financial institution routing number, the merchant's financial institution account number, the customer's name, the customer's financial institution account number, etc. Customer financial institution server 140 receives the request and, in accordance with the request, transmits the payment via RTP network 105 to the merchant financial institution server 150. The payment may be transmitted in accordance with ISO 20022.

At step 560, during the single visit, a message containing a confirmation number (confirming that the payment of the sales amount has been completed) is received. This may be performed by the customer financial institution mobile app 270 via secure Internet connection 135 to the financial institution. Customer financial institution server 140 transmits to customer device 130 a message containing a confirmation number (confirming that the payment has been made), via secure Internet connection 135. Customer financial institution mobile app 270 interprets, decodes, or otherwise processes the message and provides the message to processor 210.

At step 570, during the single visit, the confirmation number (confirming that the payment has been completed) is displayed on the display device. Processor 210 causes display device 260 to display the confirmation number.

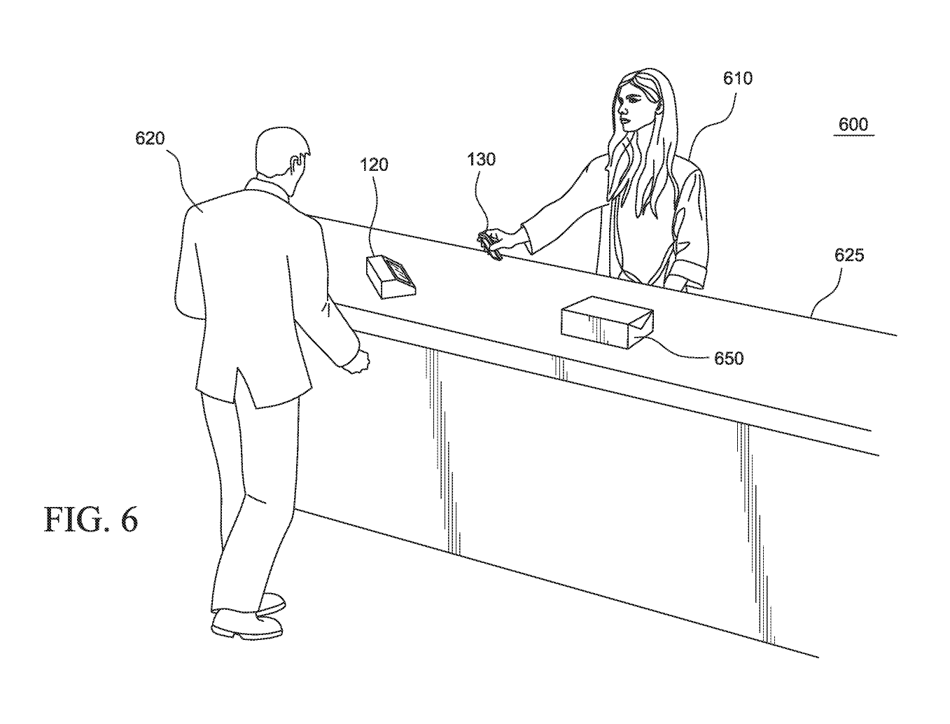

In accordance with an embodiment, systems, devices, apparatus, and methods described above may be used to conduct a transaction via a real-time payments network. In an illustrative embodiment shown in FIG. 6, a customer 610 at a merchant location 600 wishes to purchase a product 650. A cashier 620 is stationed at a counter 625. Merchant device 120 is disposed on counter 625 and is thus accessible to cashier 620 and to customer 610. The customer 610 places product 650 on counter 625 and interacts with cashier 620. After the cashier totals up the sale, customer 610 is provided the choice to pay via several methods. Supposing that the merchant accepts payments through RTP network 105, the customer may choose to pay using this method.

The transaction conducted by customer 610 and cashier 620 is discussed below with reference to FIGS. 4A-4B and FIG. 5.

In the illustrative embodiment, the merchant maintains a financial institution account at a first financial institution. Merchant financial institution server 150 is used by the first financial institution.

In the illustrative embodiment, customer 610 maintains a financial institution account at a second financial institution. Customer financial institution server 140 is used by the second financial institution.

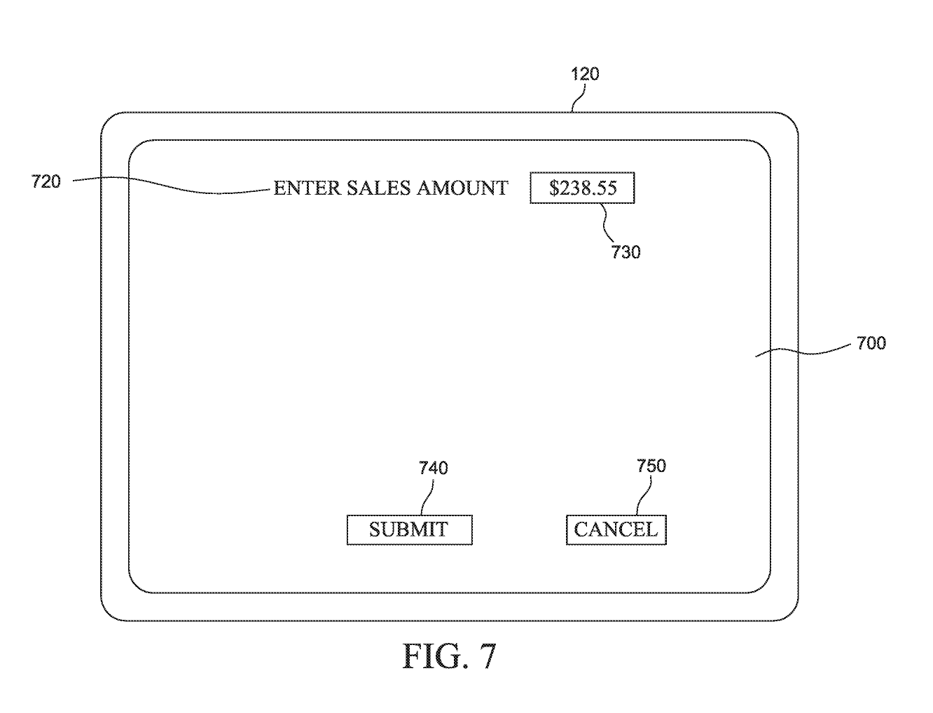

Cashier 620 activates merchant device 120. For example, cashier 620 may initiate a real-time payments application on merchant device 120. Merchant device 120 prompts cashier 620 to enter a sales amount. FIG. 7 shows a page 700 that may be displayed on merchant device 120 in accordance with an embodiment. Page 700 includes a prompt 720 that reads “ENTER SALES AMOUNT” and a field 730 in which a sales amount may be entered. Page 700 also includes a SUBMIT button 740 and a CANCEL button 750. In the illustrative embodiment, cashier 620 determines the sales amount to be $238.55, enters the sales amount in field 730 and selects SUBMIT button 740.

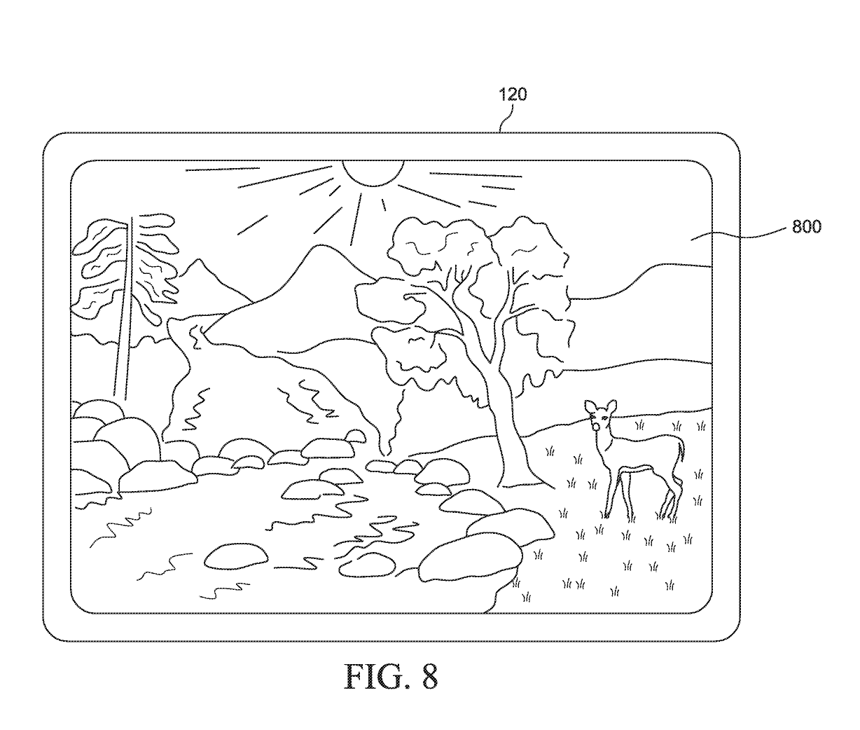

Merchant device 120 receives the sales amount (step 410). Merchant device 120 retrieves merchant data from storage and encodes the sales amount, the merchant name, a financial institution routing number associated with the merchant's financial institution, and the merchant's account number into an image (step 415). Other information may be encoded into the image. Merchant device 120 displays the image (step 420). FIG. 8 shows an image 800 containing encoded information that may be displayed by merchant device 120 in accordance with an embodiment. In other embodiments, other types of images may be displayed.

Referring again to FIG. 6, customer 610 holds customer device 130 proximate the image displayed on merchant device 120 to enable customer device 130 to scan the image. Customer device 130, utilizing customer financial institution mobile app 270, scans the image (step 510) and decodes the image to obtain the sales amount, the merchant name, a financial institution routing number associated with the merchant's financial institution, and the merchant's financial institution account number (step 520).

Customer device 130 only displays the merchant name and the sales amount to the customer. After customer confirmation is obtained, merchant financial institution information (routing number and account number) are sent to the customer's financial institution via customer financial institution mobile app 270 along with the merchant name and sales amount number, but the merchant financial institution information are not stored on customer device 130.

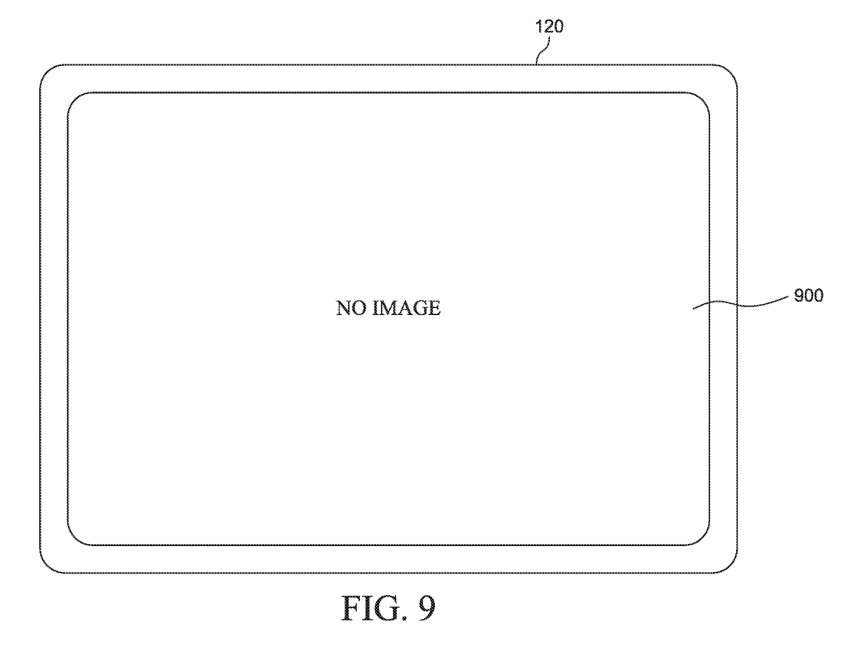

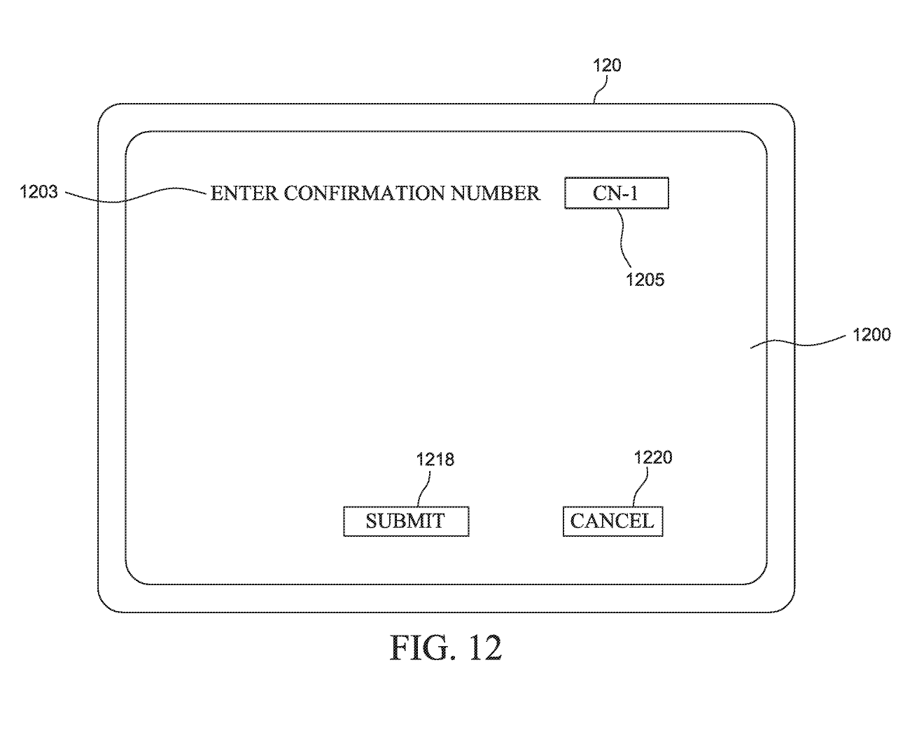

Merchant device 120 removes the image from the display (step 430). FIG. 9 shows a blank page 900 that may be displayed by merchant device 120 after the image has been removed in accordance with an embodiment. For example, merchant device 120 may display blank page 900 for a short period of time (e.g., one or two seconds) before displaying another page. For example, merchant device 120 may then display a page requesting the confirmation number from the customer, such as that shown in FIG. 12. Alternatively, after removing the image, merchant device 120 may immediately display a page such as that shown in FIG. 12 (requesting the confirmation number from the customer).

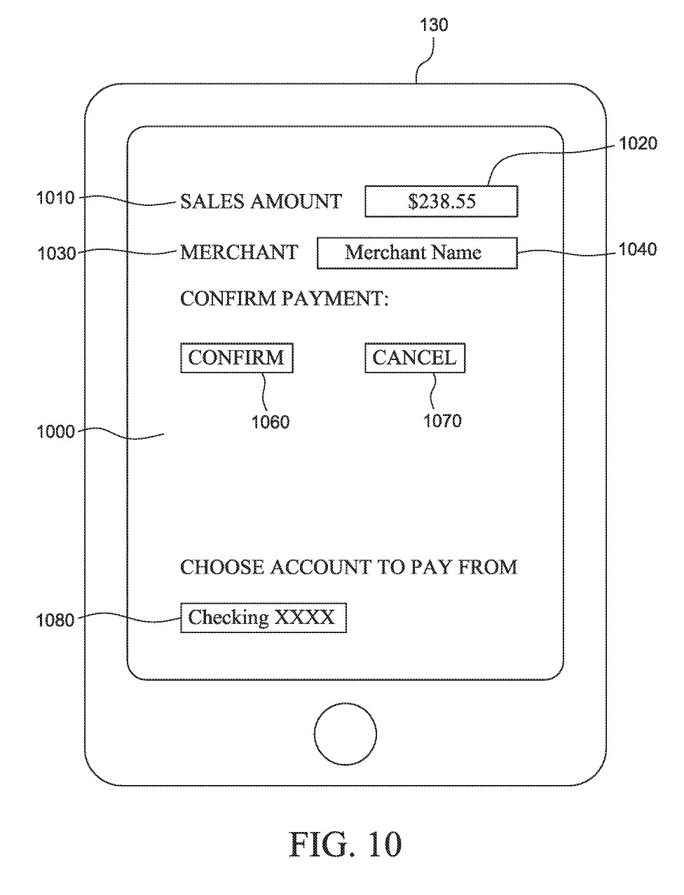

Customer device 130 now displays an option to confirm payment of the sales amount from the customer's financial institution account to the merchant's financial institution account (step 530). FIG. 10 shows a page including an option to confirm payment that may be displayed on customer device 130 in accordance with an embodiment. Page 1000 includes a sales amount line 1010, a field 1020 showing the sales amount ($238.55), a merchant line 1030, and a field 1040 showing the merchant name. Page 1000 also includes a CONFIRM button 1060 and a CANCEL button 1070. Page 1000 also includes an option 1080 for the customer to choose the financial institution account at the financial institution from which the payment should be sent.

In the illustrative embodiment, customer 610 confirms payment by selecting CONFIRM button 1060.

Customer device 130 receives the customer's selection of the CONFIRM option (step 540). Customer device 130, via the customer financial institution mobile app 270, then transmits to customer financial institution server 140 a request to make a payment of the sales amount from the customer's financial institution account to the merchant's financial institution account (step 550). For example, the request may include information such as the sales amount, the merchant name, a financial institution routing number associated with the merchant's financial institution, and the merchant's financial institution account number, the customer's name, the customer's financial institution account number, etc.

In the illustrative embodiment, customer financial institution server 140 communicates with merchant financial institution server 150 and causes a payment of the sales amount to be made from the customer's financial institution account to the merchant's financial institution account. The transaction between the customer's financial institution and the merchant's financial institution is conducted via RTP network 105 to ensure immediate payment to the merchant's financial institution account.

After the sales amount has been transferred from the customer's financial institution account to the merchant's financial institution account, customer financial institution server 140 transmits to customer device 130, via customer financial institution mobile app 270, a message including a confirmation number.

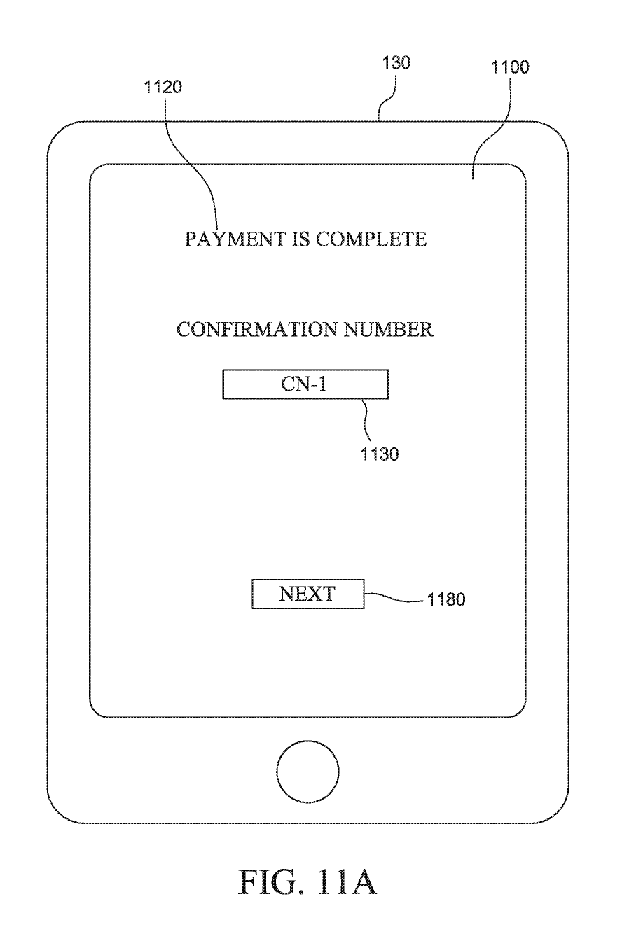

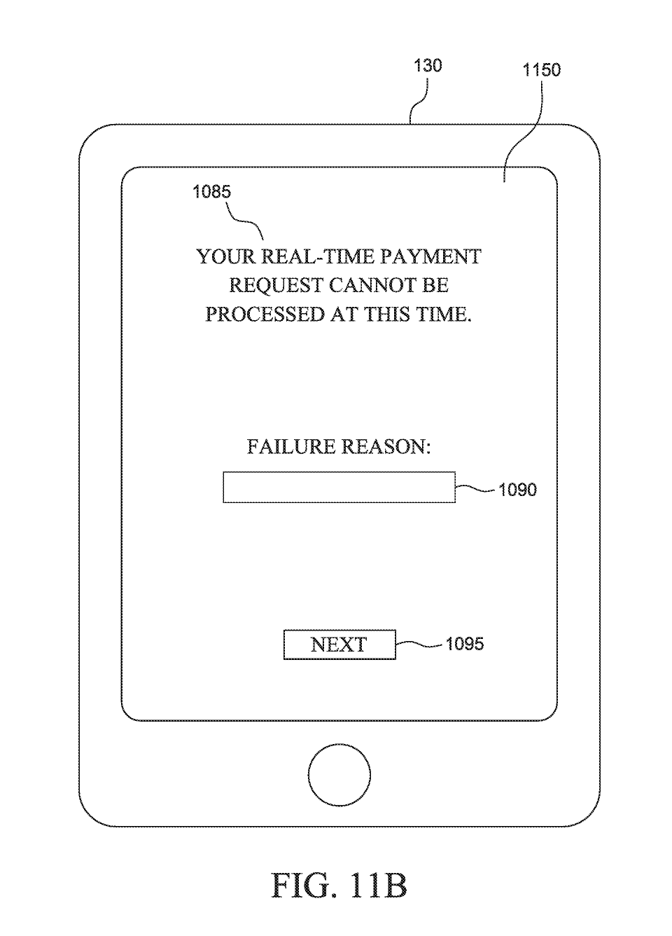

Customer device 130 receives the message containing the confirmation number (step 560) and displays the confirmation number to the customer (step 570). FIG. 11A shows a page displaying a confirmation number that may be displayed on customer device 130 in accordance with an embodiment. Page 1100 includes a payment is complete message (1120) and a field 1130 showing a confirmation number (shown as “CN-1”). FIG. 11A also includes a NEXT button 1180.

FIG. 11B shows a page 1150 that customer device 130 may display if the customer's financial institution determines that the real time payment is not possible (for example, if the customer has insufficient funds in the account). Failure message 1085 is displayed, along with a failure reason field 1090. The financial institution server populates field 1090 with an appropriate failure reason (such as insufficient funds or server unavailable). After reading these messages, the customer may choose a NEXT button 1095.

Merchant device 120 now prompts cashier 620 to enter the confirmation number (step 440). FIG. 12 shows a prompt page that may be displayed on merchant device 120 in accordance with an embodiment. Page 1200 includes a prompt line 1203 that reads “ENTER CONFIRMATION NUMBER” and a field 1205 in which a confirmation number may be entered. Page 200 also includes a SUBMIT button 1218 and a CANCEL button 1220.

In the illustrative embodiment, cashier 620 asks customer 610 for the confirmation number, and customer 610 conveys the confirmation number to cashier 620. For example, the customer may read the confirmation verbally to cashier 620, or may show the confirmation number as displayed on customer device 130 to cashier 620. In another embodiment, customer 610 may enter the confirmation number directly into merchant device 120.

Referring again to FIG. 11A, customer 610 may then select NEXT button 1180 on page 1100 of customer device 130.

In the illustrative embodiment, cashier 620 receives the confirmation number (“CN-1”) from the customer and enters the confirmation number in field 1205 of page 1200. Cashier 620 then selects SUBMIT button 1218. Merchant device 120 receives the confirmation number (step 450) and transmits to merchant financial institution server 150, via secure Internet connection 155, a query requesting validation of the confirmation number (step 460).

Merchant financial institution server 150 transmits to merchant device 120, via secure Internet connection 155, a confirmation message indicating that the confirmation number is valid.

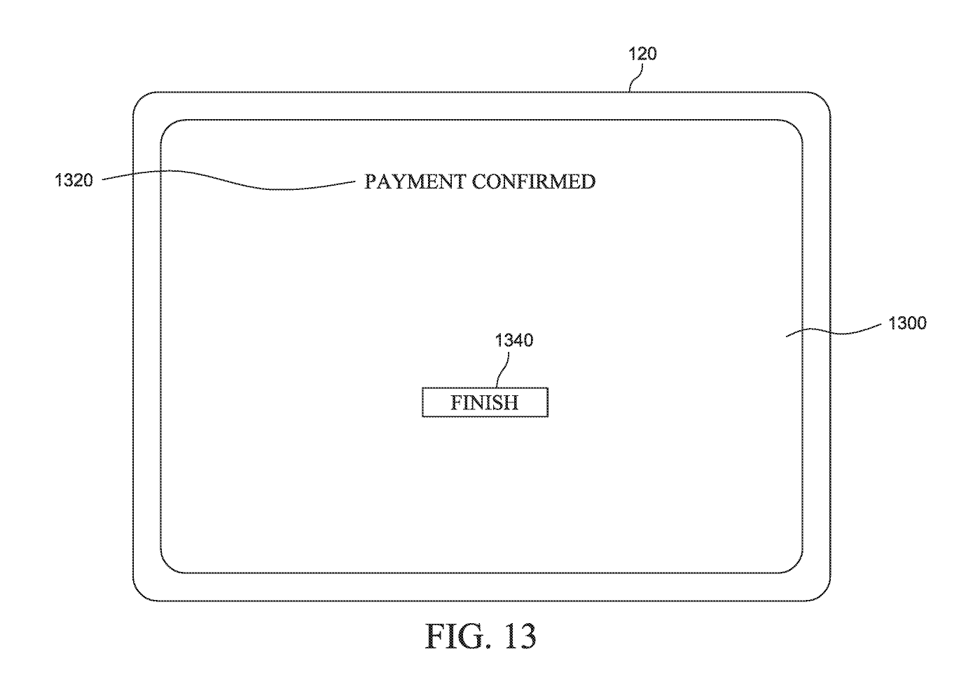

Merchant device 120 receives the confirmation message via secure Internet connection 155, from merchant financial institution server 150 (step 470) and displays a message indicating that payment of the sales amount from the customer's financial institution account to the merchant's financial institution account has been confirmed (step 480). FIG. 13 shows a confirmation page that may be displayed on merchant device 120 in accordance with an embodiment. Page 1300 includes a confirmation line 1320 that reads “PAYMENT CONFIRMED.” Page 1300 also includes a “FINISH” button 1340 to complete the process and return the merchant device display to page 700 (shown in FIG. 7) so that it is prepared to receive another sales amount.

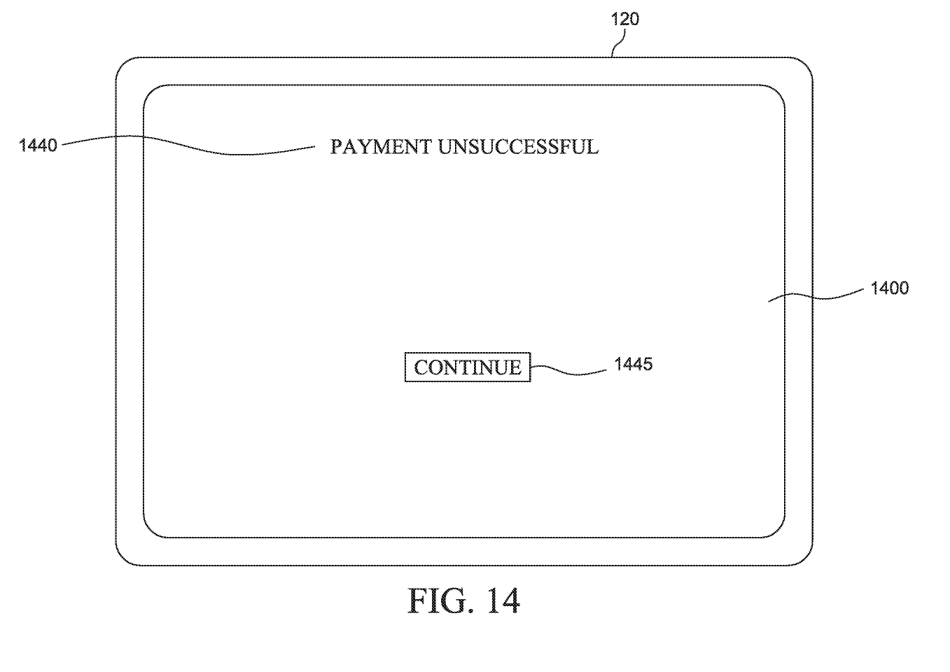

FIG. 14 displays a page 1400 that may be displayed if the merchant's financial institution cannot confirm that a payment with the specified confirmation number has been received. In such event, the merchant device 120 may return a message of “PAYMENT UNSUCCESSFUL” (line 1440). This message could be displayed for any one of several different reasons, such as if the confirmation number had been typed incorrectly, the customer had provided a fictitious or recycled confirmation number from a previous transaction, or if the connection to the merchant's financial institution had been lost. A “CONTINUE” button 1445 is displayed on page 1400 and allows the merchant to return to page 1200 (shown in FIG. 12) to re-enter a confirmation number in order to try again or to choose to cancel the transaction with “CANCEL” button 1220 and return to page 700 (FIG. 7) to start a new transaction.

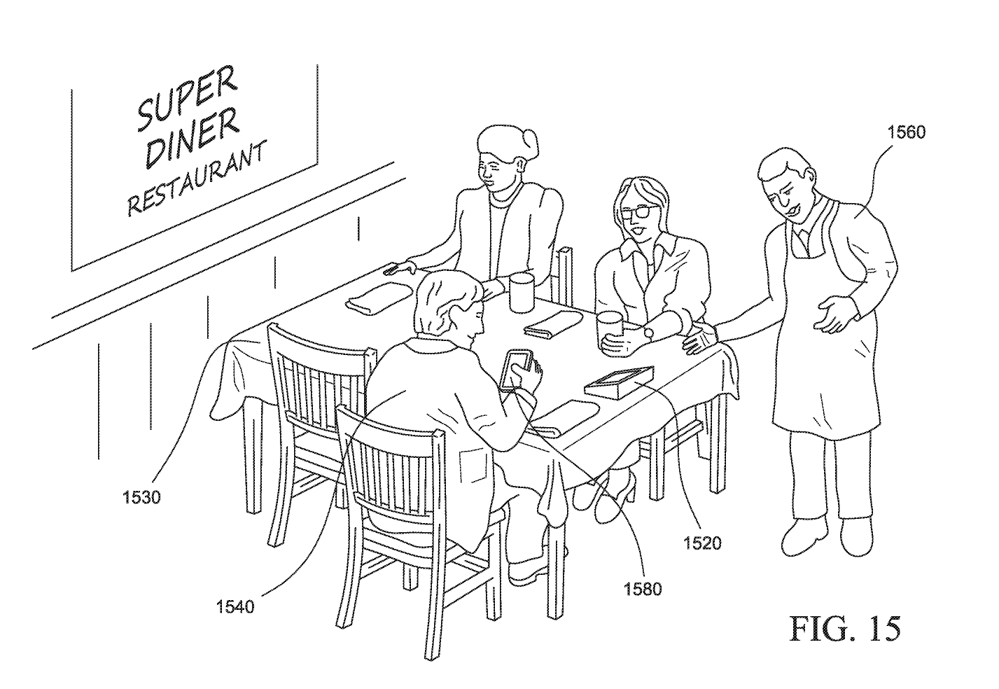

In the illustrative embodiment discussed above, merchant device 120 is a device fixed to a counter manned by a cashier. In other embodiments, a merchant device may take other forms. In accordance with an embodiment illustrated by FIG. 15, a merchant device 1520 is fixed to a customer's table 1530 inside a restaurant. When a customer 1540 seated at table 1530 wishes to pay his or her bill, a server 1560 (e.g., a waiter or waitress) may use merchant device 1520 fixed to the customer's table 1530 to conduct a transaction in a manner similar to that described above. Customer 1540 may use a customer device 1580, which may be a mobile device such as a cell phone, in a manner similar to that described above.

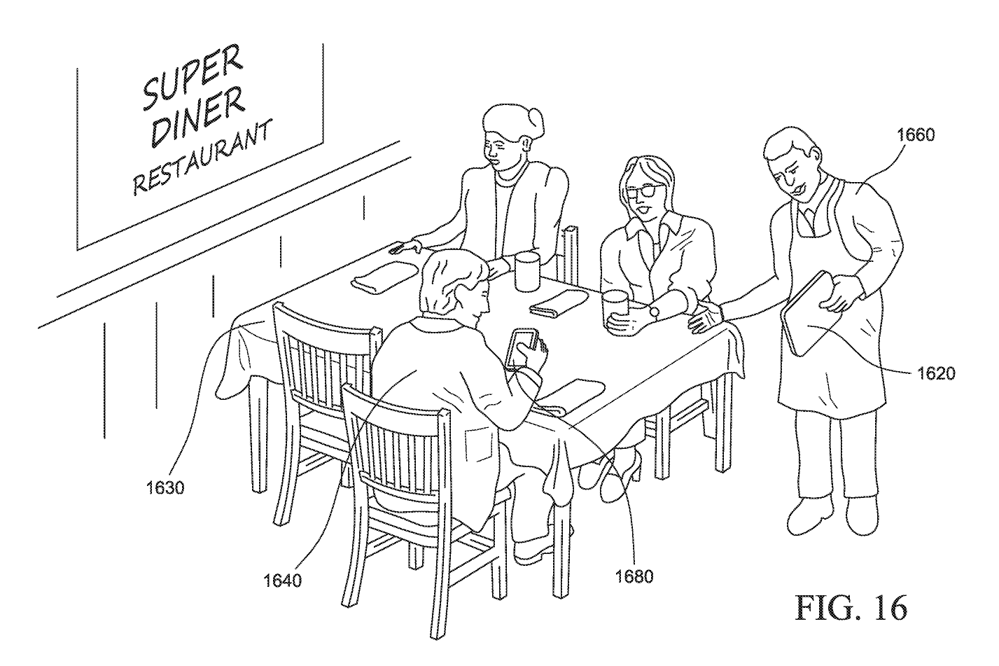

In another embodiment illustrated by FIG. 16, a merchant device 1620 is a mobile device that is carried by a server 1660 (e.g., a waiter or waitress) inside a restaurant. When a customer 1640 seated at a table 1630 in the restaurant wishes to pay his or her bill, the server 1660 may carry merchant device 1620 to the customer's table 1630 and conduct a transaction in a manner similar to that described above. Customer 1640 may use a customer device 1680, which may be a mobile device such as a cell phone, in a manner similar to that described above.

In various embodiments, merchant device 120 may be hard-wired to the merchant's financial institution server, or wirelessly connected the merchant's financial institution server. For example, merchant device 120 may be connected via a cellular network, via a Wi-Fi connection, or in another manner.

In another embodiment, merchant device 120 may provide payment confirmation directly to a point-of-sale software application. This may involve a one-way connection between the merchant device 120 and a cash register or point-of-sale computer.

In another embodiment, merchant device 120 may provide several payment options to the customer including (1) payment by credit card, (2) payment by debit card, or (3) payment via real-time payments network 105.

In accordance with another embodiment, the merchant device performs operations described herein during a single electronic communication session with a customer device, including encoding information into an image, displaying the image, transmitting, via a secure connection to the merchant's financial institution server, a query requesting a confirmation number, receiving, via a connection to the merchant's financial institution server, a confirmation message, etc.

Thus, in accordance with another embodiment, a device is provided. The device is connected by a secure Internet connection to the financial institution. The device includes a memory adapted to store first data and a display device adapted to display second data and images. The device also includes a processor configured to perform the following operations: during a single communication session with a customer device, receive a sales amount; during the single communication session, encode the sales amount, a merchant name, a financial institution routing number associated with a financial institution, and an account number associated with a financial institution account into an image; during the single communication session, display the image on the display device; during the single communication session, determine that a predetermined event has occurred; during the single communication session, remove the image from the display device in response to a determination that the predetermined event has occurred; during the single communication session, display on the display device a prompt for a confirmation number; during the single communication session, receive a confirmation number; during the single communication session, transmit to a device associated with the financial institution, via a secure Internet connection with the financial institution's server, a query requesting validation of the confirmation number; during the single communication session, receive, via a secure Internet connection with the financial institution's server, a confirmation message indicating that the confirmation number is valid; and during the single communication session, display on the display device information indicating that payment of the sales amount to the financial institution account has been confirmed.

In accordance with another embodiment, the merchant device performs operations described herein during a single electronic communication session associated with a particular sales amount. Thus, the merchant device receives a particular sales amount (for example, when a cashier enters the sales amount via a keyboard) and, during a single communication session associated with the sales amount entered (and before initiating a second communication session associated with a second sales amount), the merchant device performs operations described herein, including, for example, encoding information into an image, displaying the image, transmitting, via a secure Internet connection with the financial institution's server, a query requesting a confirmation number, receiving, via a secure Internet connection with the financial institution's server, a confirmation message, etc.

Thus, in accordance with an embodiment, a device is provided. The device is connected to a secure Internet connection. The device also includes an interface connected to the financial institution's server and adapted to transmit and receive messages. The device also includes a memory adapted to store first data and a display device adapted to display second data and images. The device also includes a processor configured to perform the following operations: during a single communication session associated with a particular sales amount, receive the particular sales amount; during the single communication session, encode the particular sales amount, a merchant name, a financial institution routing number associated with a financial institution, and an account number associated with a financial institution account into an image; during the single communication session, display the image on the display device; during the single communication session, determine that a predetermined event has occurred; during the single communication session, remove the image from the display device in response to a determination that the predetermined event has occurred; during the single communication session, display on the display device a prompt for a confirmation number; during the single communication session, receive a confirmation number; during the single communication session, transmit to a device associated with the financial institution, via a secure Internet connection with the financial institution's server, a query requesting validation of the confirmation number; during the single communication session, receive, via a secure Internet connection with the financial institution's server, a confirmation message indicating that the confirmation number is valid; and during the single communication session, display on the display device information indicating that payment of the particular sales amount to the financial institution account has been confirmed.

Advantageously, payments made using the systems, methods, and devices described herein are immediate and thus provide an advantage both for the merchant and for the customer. Additionally, payments made using the systems, methods, and devices described herein are less risky for a merchant because they are final. There are no chargeback or dispute rights for the purchaser. The purchaser cannot later state that the payment was unauthorized. Also, payments made using the systems, methods, and devices described herein are advantageous for the customer because the customer is not required to provide his or her financial information to the merchant.

In various embodiments, the method steps described herein, including the method steps described in FIG. 4A-4B and/or FIG. 5, may be performed in an order different from the particular order described or shown. In other embodiments, other steps may be provided, or steps may be eliminated, from the described methods.

Systems, apparatus, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Systems, apparatus, and methods described herein may be implemented using computers operating in a client-server relationship. Typically, in such a system, the client computers are located remotely from the server computer and interact via a network. The client-server relationship may be defined and controlled by computer programs running on the respective client and server computers.

Systems, apparatus, and methods described herein may be used within a network-based cloud computing system. In such a network-based cloud computing system, a server or another processor that is connected to a network communicates with one or more client computers via a network. A client computer may communicate with the server via a network browser application residing and operating on the client computer, for example. A client computer may store data on the server and access the data via the network. A client computer may transmit requests for data, or requests for online services, to the server via the network. The server may perform requested services and provide data to the client computer(s). The server may also transmit data adapted to cause a client computer to perform a specified function, e.g., to perform a calculation, to display specified data on a screen, etc.

Systems, apparatus, and methods described herein may be implemented using a computer program product tangibly embodied in an information carrier, e.g., in a non-transitory machine-readable storage device, for execution by a programmable processor; and the method steps described herein, including one or more of the steps of FIG. 4A-4B and/or FIG. 5, may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

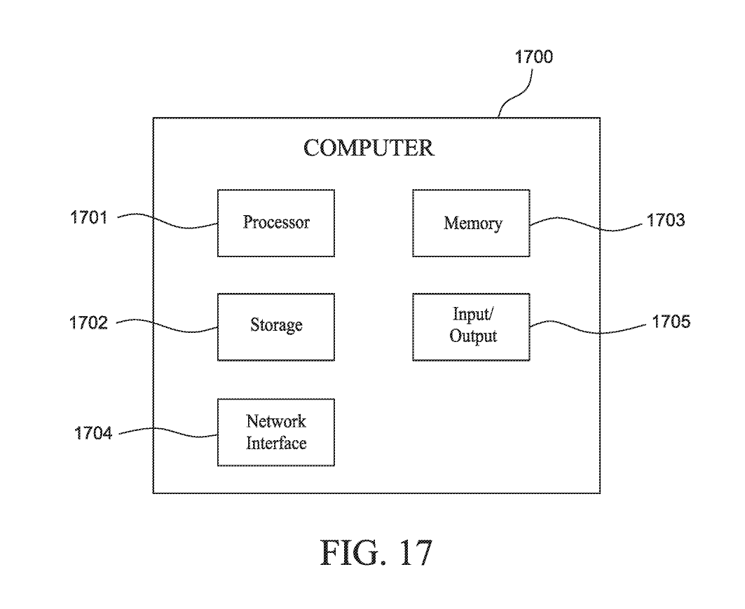

A high-level block diagram of an exemplary computer that may be used to implement systems, apparatus and methods described herein is illustrated in FIG. 17. Computer 1700 includes a processor 1701 operatively coupled to a data storage device 1702 and a memory 1703. Processor 1701 controls the overall operation of computer 1700 by executing computer program instructions that define such operations. The computer program instructions may be stored in data storage device 1702, or other computer readable medium, and loaded into memory 1703 when execution of the computer program instructions is desired.

Thus, the method steps of FIG. 4A-4B and/or FIG. 5 can be defined by the computer program instructions stored in memory 1703 and/or data storage device 1702 and controlled by the processor 1701 executing the computer program instructions. For example, the computer program instructions can be implemented as computer executable code programmed by one skilled in the art to perform an algorithm defined by the method steps of FIG. 4A-4B and/or FIG. 5. Accordingly, by executing the computer program instructions, the processor 1701 executes an algorithm defined by the method steps of FIG. 4A-4B and/or FIG. 5. Computer 1700 also includes one or more network interfaces 1704 for communicating with other devices via a network. Computer 1700 also includes one or more input/output devices 1705 that enable user interaction with computer 1700 (e.g., display, keyboard, mouse, speakers, buttons, etc.).

Processor 1701 may include both general and special purpose microprocessors, and may be the sole processor or one of multiple processors of computer 1700. Processor 1701 may include one or more central processing units (CPUs), for example. Processor 1701, data storage device 1702, and/or memory 1703 may include, be supplemented by, or incorporated in, one or more application-specific integrated circuits (ASICs) and/or one or more field programmable gate arrays (FPGAs).

Data storage device 1702 and memory 1703 each include a tangible non-transitory computer readable storage medium. Data storage device 1702, and memory 1703, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 1705 may include peripherals, such as a printer, scanner, display screen, etc. For example, input/output devices 1705 may include a display device such as a cathode ray tube (CRT) or liquid crystal display (LCD) monitor for displaying information to the user, a keyboard, and a pointing device such as a mouse or a trackball by which the user can provide input to computer 1700.

One skilled in the art will recognize that an implementation of an actual computer or computer system may have other structures and may contain other components as well, and that FIG. 17 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A device connected to a financial institution that is connected to a real-time payments network, the device comprising:
an interface connected to a financial institution, the interface adapted to transmit and receive messages;
a memory adapted to store first data;
a display device adapted to display second data and images;
a processor configured to:
during a single visit by a customer to a merchant location, receive a sales amount;
during the single visit, encode the sales amount, a merchant name, a financial institution routing number associated with a financial institution connected to a real-time payments network, and an account number associated with a financial institution account into an image;
during the single visit, display the image on the display device;
during the single visit, determine that a predetermined event has occurred;
during the single visit, remove the image from the display device in response to determining that the predetermined event has occurred;
during the single visit, display on the display device a prompt for a confirmation number;
during the single visit, receive a confirmation number;
during the single visit, transmit to a device associated with the financial institution, via a secure Internet connection, a query requesting validation of the confirmation number;
during the single visit, receive, via the secure Internet connection, a confirmation message indicating that the confirmation number is valid; and
during the single visit, display on the display device information indicating that payment of the sales amount to the financial institution account has been confirmed.

2. The device of claim 1, wherein the real-time payments network is the Real-Time Payments (RTP®) network maintained by The Clearing House (TCH).

3. The device of claim 1, wherein the device is located at a point-of-sale at the merchant location.

4. The device of claim 3, wherein the merchant location comprises one of a retail store, a restaurant, and a movie theater.

5. The device of claim 4, wherein the device is one of: a device fixed to a surface within the merchant location, and a mobile device.

6. The device of claim 1, wherein the predetermined event is one of: the image has been scanned by the user device, and the image has been displayed for a predetermined period of time.

7. The device of claim 1, wherein the image comprises an image of a familiar object.

8. The device of claim 1, wherein the processor uses a symmetric key algorithm to encode the sales amount, a merchant name, a financial institution routing number associated with a financial institution, and an account number associated with a financial institution account into an image.

9. A method comprising:
during a single visit by a customer to a merchant location, receiving a sales amount;
during the single visit, encoding the sales amount, a merchant name, a financial institution routing number associated with a financial institution connected to a real-time payments network, and an account number associated with a financial institution account into an image;
during the single visit, displaying the image on a display device;
during the single visit, determining that a predetermined event has occurred;
during the single visit, removing the image from the display device in response to determining that the predetermined event has occurred;
during the single visit, displaying on the display device a prompt for a confirmation number;
during the single visit, receiving a confirmation number;
during the single visit, transmitting to a device associated with the financial institution, via a secure Internet connection with the financial institution, a query requesting validation of the confirmation number;
during the single visit, receiving, via the secure Internet connection with the financial institution, a confirmation message indicating that the confirmation number is valid; and
during the single visit, displaying on the display device information indicating that payment of the sales amount to the financial institution account has been completed.

10. The method of claim 9, wherein the real-time payments network is the Real-Time Payments (RTP®) network maintained by The Clearing House (TCH).

11. The method of claim 10, further comprising:
during a single visit by a customer to a merchant location, receiving a sales amount, by a processing device located at the merchant location;
during the single visit, encoding the sales amount, a merchant name, a financial institution routing number associated with a financial institution connected to the real-time payments network, and an account number associated with a financial institution account into an image, by the processing device;
during the single visit, displaying the image on a display device, by the processing device;
during the single visit, determining that a predetermined event has occurred, by the processing device;
during the single visit, removing the image from the display device in response to determining that the predetermined event has occurred, by the processing device;
during the single visit, displaying on the display device a prompt for a confirmation number, by the processing device;
during the single visit, receiving a confirmation number, by the processing device;
during the single visit, transmitting to a device associated with the financial institution, via a secure Internet connection to the financial institution, a query requesting validation of the confirmation number, by the processing device;
during the single visit, receiving, via a secure Internet connection with the financial institution, a confirmation message indicating that the confirmation number is valid, by the processing device; and
during the single visit, displaying on the display device information indicating that payment of the sales amount to the financial institution account has been confirmed, by the processing device.

12. The method of claim 11, wherein the processing device is located at a point-of-sale at the merchant location.

13. The method of claim 12, wherein the merchant location comprises one of a retail store, a restaurant, and a movie theater.

14. The method of claim 13, wherein the processing device is one of: a device fixed to a surface within the merchant location, and a mobile device.

15. The method of claim 9, wherein the predetermined event is one of: the image has been scanned by the user device, and the image has been displayed for a predetermined period of time.

16. A device containing a mobile banking app that is configured to securely connect to a financial institution, the device comprising:
an interface connected to a financial institution connected to a real-time payments network, the interface adapted to transmit and receive messages;
a memory adapted to read and transmit a first account number associated with a financial institution account;
a display device adapted to display second data and images;
a processor configured to:
during a single visit by a user to a merchant location, scan an image;
during the single visit, decode the image to obtain a sales amount, a name of a merchant, a routing number of the financial institution connected to the real-time payments network, and a first account number of a first financial institution account;
during the single visit, display on the display device an option to confirm payment of the sales amount from a second financial institution account to the first financial institution account;
during the single visit, receive a selection of the option;
during the single visit, transmit via a secure Internet connection with a financial institution a request to make a payment of the sales amount from the second financial institution account to the first financial institution account;
during the single visit, receive via a secure Internet connection a message confirming that the payment of the sales amount has been completed; and
during the single visit, display on the display device information confirming that the payment of the sales amount has been completed.

17. The device of claim 16, wherein the real-time payments network is the Real-Time Payments (RTP®) network maintained by The Clearing House (TCH).

18. The device of claim 16, wherein the processor uses a symmetric key algorithm to decode the image.

19. The device of claim 16, wherein the request includes the sales amount, the name of the merchant, the financial institution routing number of the financial institution, and the first account number of the first financial institution account.

20. A device connected to a financial institution, the device comprising:
an interface adapted to transmit and receive messages;
a memory adapted to store first data;
a display device adapted to display second data and images;
a processor configured to:
during a single communication session with a customer device, receive a sales amount;
during the single communication session, encode the sales amount, a merchant name, a financial institution routing number associated with a financial institution connected to a real-time payments network, and an account number associated with a financial institution account into an image;
during the single communication session, display the image on the display device;
during the single communication session, determine that a predetermined event has occurred;
during the single communication session, remove the image from the display device in response to determining that the predetermined event has occurred;
during the single communication session, display on the display device a prompt for a confirmation number;
during the single communication session, receive a confirmation number;
during the single communication session, transmit to a device associated with the financial institution, via a secure Internet connection, a query requesting validation of the confirmation number;
during the single communication session, receive, via a secure Internet connection with the financial institution, a confirmation message indicating that the confirmation number is valid; and
during the single communication session, display on the display device information indicating that payment of the sales amount to the financial institution account has been confirmed.

21. A device connected to a financial institution, the device comprising:
an interface connected to a financial institution, the interface adapted to transmit and receive messages;
a memory adapted to store first data;
a display device adapted to display second data and images;
a processor configured to:
during a single communication session associated with a particular sales amount, receive a sales amount;
during the single communication session, encode the particular sales amount, a merchant name, a financial institution routing number associated with a financial institution connected to a real-time payments network, and an account number associated with a financial institution account into an image;
during the single communication session, display the image on the display device;
during the single communication session, determine that a predetermined event has occurred;
during the single communication session, remove the image from the display device in response to a determining that the predetermined event has occurred;
during the single communication session, display on the display device a prompt for a confirmation number;
during the single communication session, receive a confirmation number;
during the single communication session, transmit to a device associated with the financial institution, via a secure Internet connection, a query requesting validation of the confirmation number;
during the single communication session, receive, via a secure Internet connection to the financial institution, a confirmation message indicating that the confirmation number is valid; and
during the single communication session, display on the display device information indicating that payment of the particular sales amount to the financial institution account has been confirmed.
